(19) United States
(12) Patent Application Publication
(10) Pub. No.: US 2025/0254678 A1
(43) Pub. Date: Aug. 7, 2025

(54) METHODS FOR NEW DATA INDICATOR (NDI) FIELD ALIGNMENT FOR RELIABLE RECEPTION OF MULTICAST TRAFFIC

(71) Applicant: Nokia Technologies Oy, Espoo (FI)

(72) Inventors: Athul PRASAD, Naperville, IL (US); David NAVRÁTIL, Espoo (FI); Naizheng ZHENG, Beijing (CN); Ugur Baran ELMALI, Munich (DE); David BHATOOLAUL, Swindon (GB)

(21) Appl. No.: 18/857,104

(22) PCT Filed: Apr. 24, 2022
(86) PCT No.: PCT/CN2022/088775

§ 371 Date: Oct. 15, 2024

(51) Int. Cl. H04W 72/121; H04L 1/1812; H04W 72/044; H04W 72/1273; H04W 72/232

(52) U.S. Cl. CPC H04W 72/121; H04L 1/1812; H04W 72/044; H04W 72/1273; H04W 72/232

(57) ABSTRACT

Systems, methods, apparatuses, and computer program products for sending a dummy or blank DCI to a UE in order to align the current value of the NDI field for the HPID intended to be used for the upcoming multicast transmission. One method may include selecting, by a NE, a smaller group of UE with the same NDI value from among two groups of UE of a group size smaller than a configured threshold value; transmitting, by the NE, DCI to the group of UE; and transmitting, by the NE, at least one of initial PTP transmissions and subsequent PTP or PTM retransmissions with the NDI value toggled from the DCI.

### TECHNICAL FIELD

Some example embodiments may generally relate to mobile or wireless telecommunication systems, such as Long Term Evolution (LTE), fifth generation (5G) radio access technology (RAT), new radio (NR) access technology, sixth generation (6G), and/or other communications systems. For example, certain example embodiments may relate to systems and/or methods for sending a dummy or blank downlink control information (DCI) to a user equipment (UE).

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include selecting, by a network entity, a smaller group of user equipment with the same new data indicator value from among two groups of user equipment of a group size smaller than a configured threshold value. The method may further include transmitting, by the network entity, downlink control information to the group of user equipment. The downlink control information may be free of grants for downlink data scheduling associated with the group of user equipment. The method may further include transmitting, by the network entity, at least one of initial point-to-point transmissions and subsequent point-to-point or point-to-multipoint retransmissions with the new data indicator value toggled from the downlink control information.

In accordance with certain example embodiments, an apparatus may include means for selecting a smaller group of user equipment with the same new data indicator value from among two groups of user equipment of a group size smaller than a configured threshold value. The apparatus may further include means for transmitting downlink control information to the group of user equipment. The downlink control information may be free of grants for downlink data scheduling associated with the group of user equipment. The apparatus may further include means for transmitting at least one of initial point-to-point transmissions and subsequent point-to-point or point-to-multipoint retransmissions with the new data indicator value toggled from the downlink control information.

In accordance with various example embodiments, a non-transitory computer readable medium may be encoded with instructions that may, when executed in hardware, perform a method. The method may include selecting a smaller group of user equipment with the same new data indicator value from among two groups of user equipment of a group size smaller than a configured threshold value. The method may further include transmitting downlink control information to the group of user equipment. The downlink control information may be free of grants for downlink data scheduling associated with the group of user equipment. The method may further include transmitting at least one of initial point-to-point transmissions and subsequent point-to-point or point-to-multipoint retransmissions with the new data indicator value toggled from the downlink control information.

In accordance with some example embodiments, a computer program product may perform a method. The method may include selecting a smaller group of user equipment with the same new data indicator value from among two groups of user equipment of a group size smaller than a configured threshold value. The method may further include transmitting downlink control information to the group of user equipment. The downlink control information may be free of grants for downlink data scheduling associated with the group of user equipment. The method may further include transmitting at least one of initial point-to-point transmissions and subsequent point-to-point or point-to-multipoint retransmissions with the new data indicator value toggled from the downlink control information.

In accordance with certain example embodiments, an apparatus may include at least one processor and at least one memory including computer program code. The at least one memory and the computer program code may be configured to, with the at least one processor, cause the apparatus to at least select a smaller group of user equipment with the same new data indicator value from among two groups of user equipment of a group size smaller than a configured threshold value. The at least one memory and the computer program code may be further configured to, with the at least one processor, cause the apparatus to at least transmit downlink control information to the group of user equipment. The downlink control information may be free of grants for downlink data scheduling associated with the group of user equipment. The at least one memory and the computer program code may be further configured to, with the at least one processor, cause the apparatus to at least transmit at least one of initial point-to-point transmissions and subsequent point-to-point or point-to-multipoint retransmissions with the new data indicator value toggled from the downlink control information.

In accordance with various example embodiments, an apparatus may include circuitry configured to select a smaller group of user equipment with the same new data indicator value from among two groups of user equipment of a group size smaller than a configured threshold value. The circuitry may further be configured to transmit downlink control information to the group of user equipment. The downlink control information may be free of grants for downlink data scheduling associated with the group of user equipment. The circuitry may further be configured to transmit at least one of initial point-to-point transmissions and subsequent point-to-point or point-to-multipoint retransmissions with the new data indicator value toggled from the downlink control information.

In accordance with some example embodiments, a method may include receiving, by a user equipment, downlink control information from a network entity. The downlink control information may be free of grants for downlink data scheduling associated with the group of user equipment. The method may further include, in response to receiving the downlink control information, updating, by the user equipment, a new data indicator field value of latest transmission.

In accordance with certain example embodiments, an apparatus may include means for receiving downlink control information from a network entity. The downlink control information may be free of grants for downlink data scheduling associated with the group of user equipment. The apparatus may further include means for, in response to receiving the downlink control information, updating a new data indicator field value of latest transmission.

In accordance with various example embodiments, a non-transitory computer readable medium may be encoded with instructions that may, when executed in hardware, perform a method. The method may include receiving downlink control information from a network entity. The downlink control information may be free of grants for downlink data scheduling associated with the group of user equipment. The method may further include, in response to receiving the downlink control information, updating a new data indicator field value of latest transmission.

In accordance with some example embodiments, a computer program product may perform a method. The method may include receiving downlink control information from a network entity. The downlink control information may be free of grants for downlink data scheduling associated with the group of user equipment. The method may further include, in response to receiving the downlink control information, updating a new data indicator field value of latest transmission.

In accordance with certain example embodiments, an apparatus may include at least one processor and at least one memory including computer program code. The at least one memory and the computer program code may be configured to, with the at least one processor, cause the apparatus to at least receive downlink control information from a network entity. The downlink control information may be free of grants for downlink data scheduling associated with the group of user equipment. The at least one memory and the computer program code may be further configured to, with the at least one processor, cause the apparatus to at least, in response to receiving the downlink control information, update a new data indicator field value of latest transmission.

In accordance with various example embodiments, an apparatus may include circuitry configured to receive downlink control information from a network entity. The downlink control information may be free of grants for downlink data scheduling associated with the group of user equipment. The circuitry may further be configured to, in response to receiving the downlink control information, update a new data indicator field value of latest transmission.

### BRIEF DESCRIPTION OF THE DRA WINGS

For a proper understanding of example embodiments, reference should be made to the accompanying drawings, wherein:

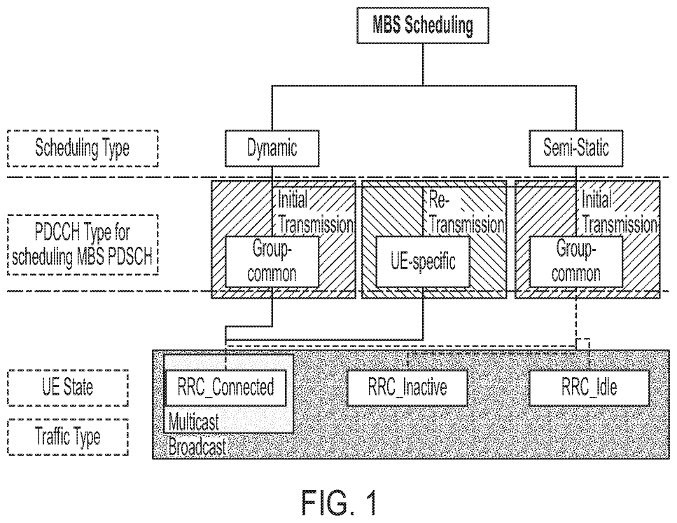

FIG. 1 illustrates a summary of various possible scheduling types for initial transmission and re-transmission.

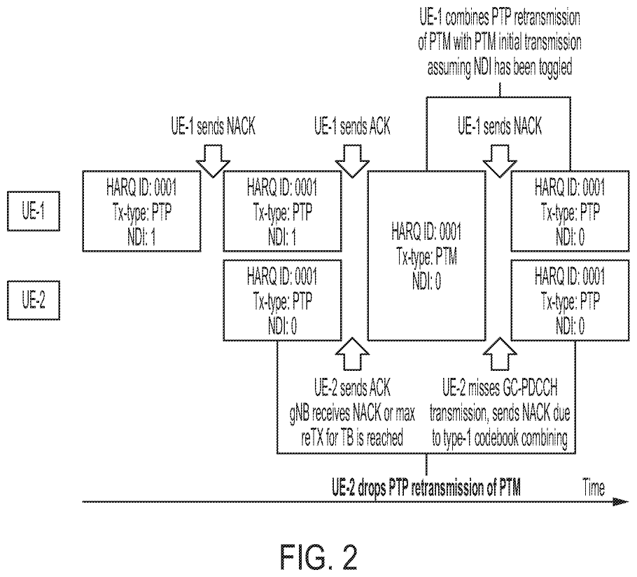

FIG. 2 illustrates an example of a scenario related to UE dropping point-to-point (PTP) retransmission of point-to-multipoint (PTM).

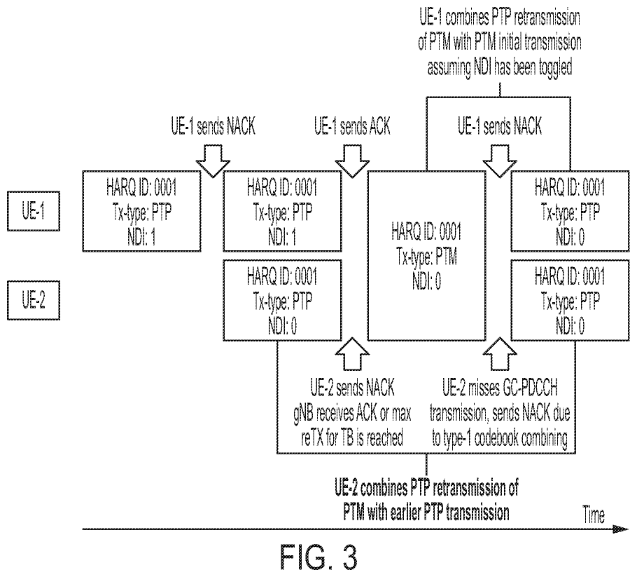

FIG. 3 illustrates an example of a scenario related to soft-combining PTP retransmission of PTM with earlier PTP transmission.

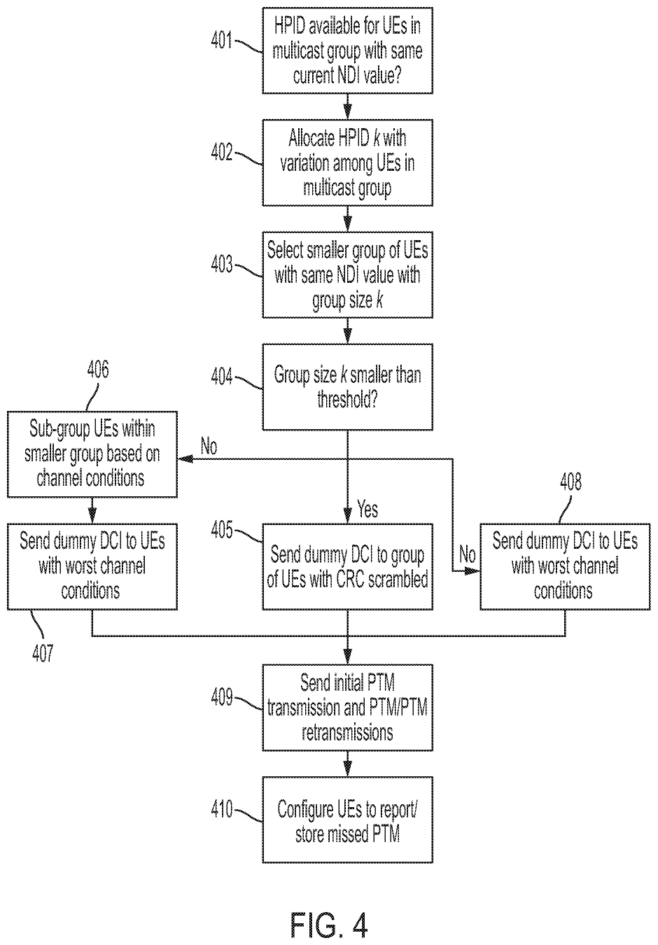

FIG. 4 illustrates an example of a flow diagram of a method according to various example embodiments.

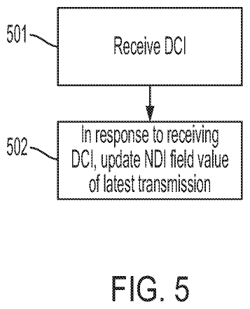

FIG. 5 illustrates an example of a flow diagram of a method according to various example embodiments.

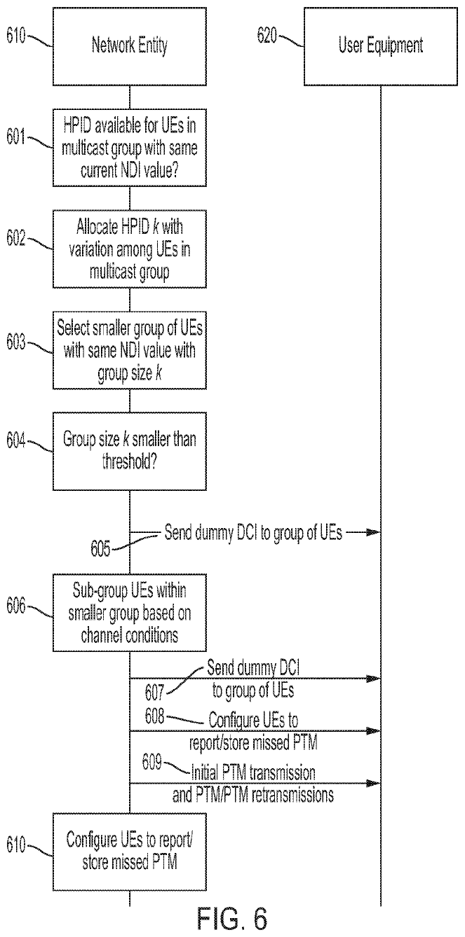

FIG. 6 illustrates an example of a signaling diagram according to certain example embodiments.

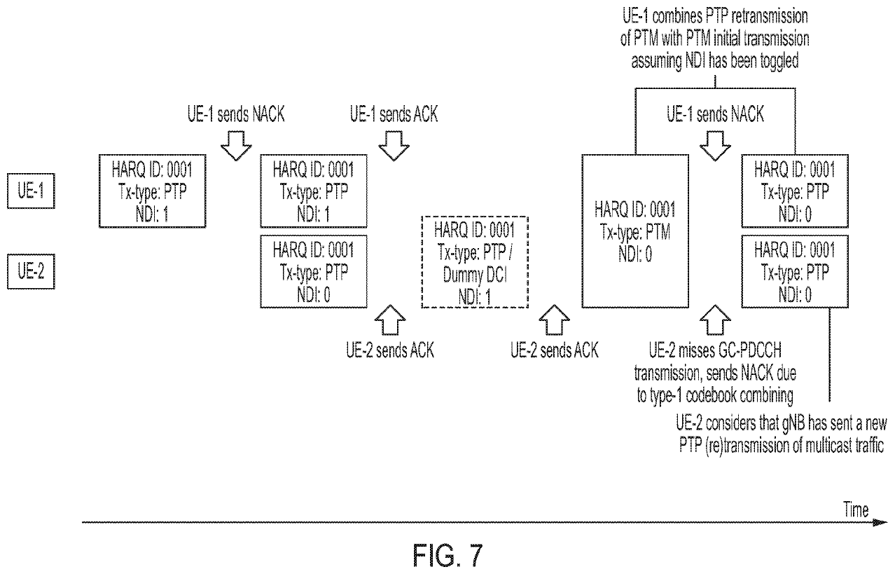

FIG. 7 illustrates an example of dummy DCI transmission and missed initial PTM transmission handling.

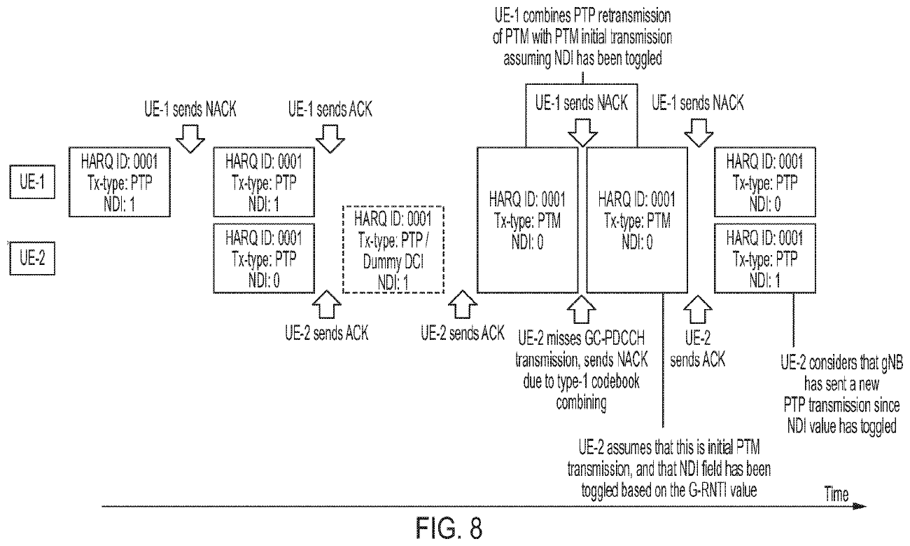

FIG. 8 illustrates some benefits of using the dummy DCI with predictable UE behavior based on legacy NDI field interpretation.

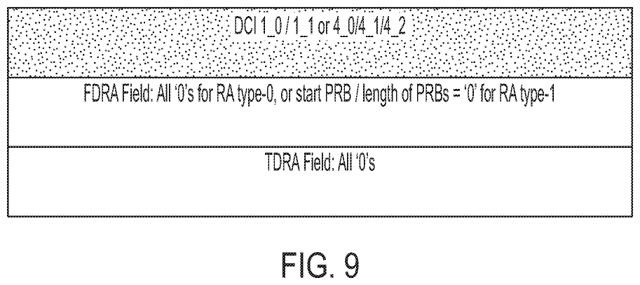

FIG. 9 illustrates some examples of DCI field values for dummy DCI.

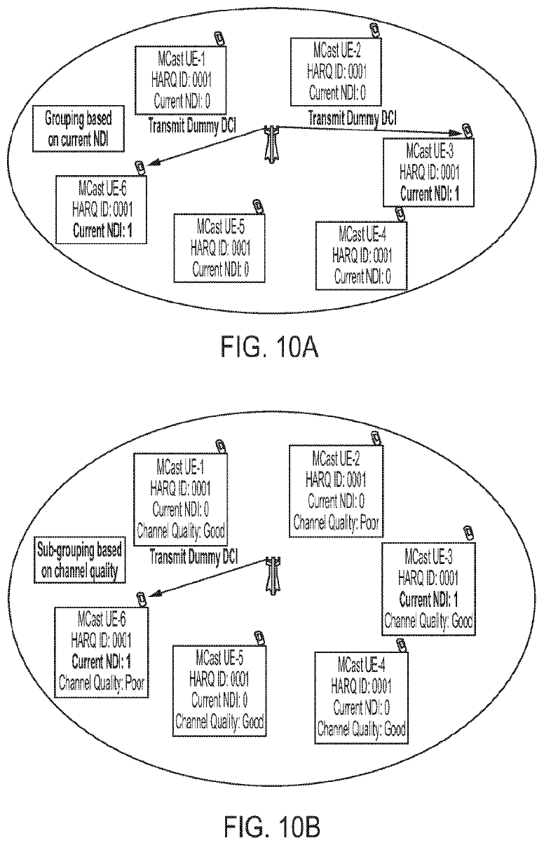

FIG. 10 illustrates an example of user grouping/sub-grouping based on current NDI value and channel quality.

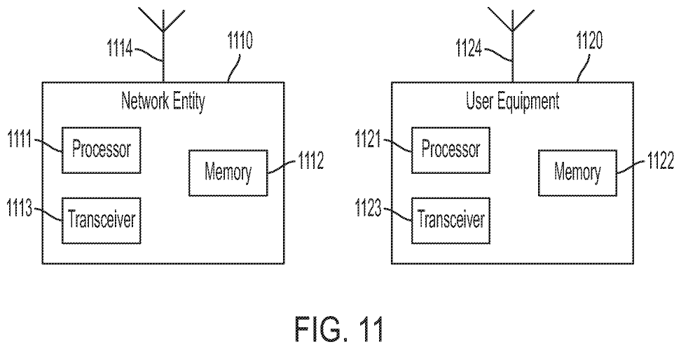

FIG. 11 illustrates an example of various network devices according to some example embodiments.

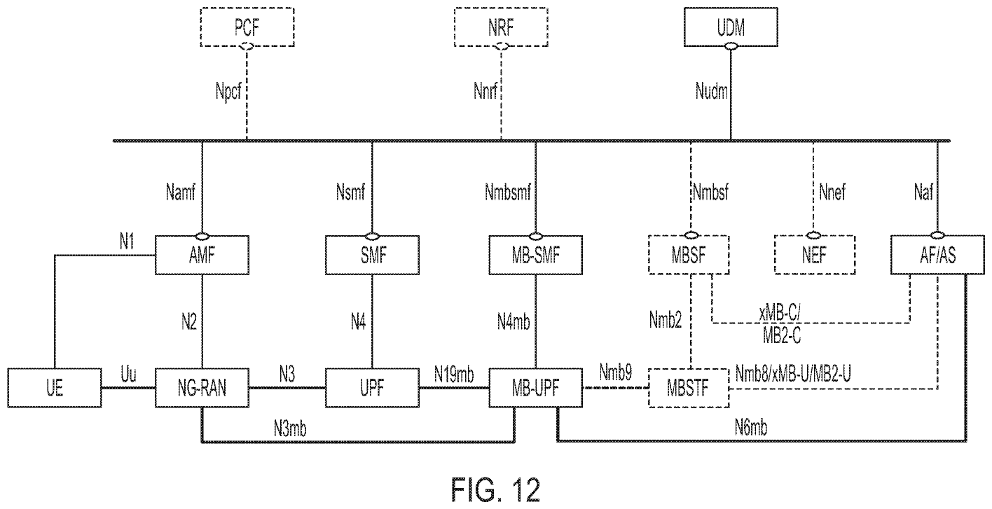

FIG. 12 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for sending a dummy or blank DCI to a UE in order to align the current value of the NDI field for the hybrid automatic repeat request process identifier (HPID) intended to be used for the upcoming multicast transmission is not intended to limit the scope of certain example embodiments, but is instead representative of selected example embodiments.

As part of the development of 5G/NR multicast, Third Generation Partnership Project (3GPP) may include mechanisms to enable the delivery of multicast/broadcast traffic to a multitude of UEs. This may include defining group scheduling mechanisms that enable the multicast/broadcast traffic to be scheduled using the common data channel resources, while maintaining maximum commonalities with the currently defined unicast scheduling and operation mechanisms. One of the objectives includes support for idle and inactive mode UEs, which could also be supported along with connected mode UEs for multicast reception.

In 3GPP 4G, group scheduling mechanisms were enabled using semi-static or dynamic broadcast signalling of control information that pointed to semi-static or dynamic shared data channel resources for evolved multicast broadcast multimedia service (eMBMS) and single-cell PTM (SC-PTM). Due to the support for receive-only mode UEs in eMBMS and SC-PTM, more limitations were imposed on the system design, such as the support for devices that are not registered with the network and idle mode devices, which had a significant impact on how the multicast data/traffic channel (MTCH) and multicast control channel (MCCH) information was sent using the physical channel, whether via physical downlink shared channel (PDSCH) or physical multicast channel (PMCH). Various physical layer scheduling concepts (e.g., bandwidth parts) did not exist for LTE; further, logical channels (e.g., SC-MCCH/MTCH) are not defined for 5G/NR for connected mode, making it difficult to redefine LTE-based multicast-broadcast features for 5G. PDCCH scheduling in 5G/NR is also significantly different from LTE, which makes it challenging to adapt LTE parameters for 5G uses.

As shown in FIG. 1, group-common PDCCH may be supported using either dynamic or semi-static/semi-persistent scheduling for group-common PDSCH of multicast traffic (i.e., “PTM scheme 1”). For group-common PDCCH, the CRC of the DCI may be scrambled using a group-common radio network temporary identifier (RNTI). UE-specific PDCCH may also be supported for the retransmission of the multicast traffic; such retransmissions may be used to enhance the reliability of the multicast traffic reception, and to improve the spectral efficiency of the network. The CRC of the UE-specific PDCCH could be scrambled using the UE-specific C-RNTI (i.e., “PTP retransmission for PTM scheme 1”); the associated PDSCH resources could also be UE-specific.

Another consideration is that the HARQ process ID utilized for unicast and multicast initial transmissions and re-transmissions could be dynamically assigned by the gNB. Hence, there are no reserved HARQ process IDs for various traffic types, and the gNB implementation would need to define which HARQ process ID should be utilized for the transmission of various transport blocks. Thus, the new data indicator (NDI) field in the DCI would convey the information whether the received transmission is an initial one or a retransmission. 3GPP Rel-17 MBS supports both HARQ ACK/NACK feedback—where the UEs receiving the PTM traffic would send ACK and NACK of the received TB—and NACK-only feedback—where the UEs receiving PTM traffic would only send a NACK-only feedback only in case of failure to decode a TB.

For NDI toggling for PTM/multicast initial transmission and PTP/PTM retransmission, if the downlink assignment is for C-RNTI, and if the previous downlink assignment indicated to the HARQ entity of the same HARQ process was either a downlink assignment received for the MAC entity's G-CS-RNTI or a configured downlink assignment for MBS the NDI may be considered to have been toggled regardless of the value of the NDI. Alternatively, the NDI may be considered to have been toggled regardless of the value of the NDI if the downlink assignment is for G-RNTI, and if the previous downlink assignment indicated to the HARQ entity of the same HARQ process was either a downlink assignment received for the MAC entity's G-CS-RNTI or other G-RNTI or C-RNTI or a configured downlink assignment for MBS or unicast. Thus, once the UE receives a PTM/multicast initial transmission, the UE may assume that the NDI value has been toggled, regardless of the actual value of the NDI field. This is important for GC-PDCCH since, with dynamic allocation of HARQ process ID, the NDI values could be different for different UEs that are interested in receiving multicast traffic.

Separately, the same HARQ process ID and NDI may be used for PTM scheme 1 (re)transmissions and PTP retransmissions of the same TB. Similar to unicast HARQ process ID and NDI, the values of these fields in the DCI may remain the same for the PTM initial transmission and subsequent retransmissions using PTP or PTM.

FIGS. 2 and 3 illustrate examples of problematic scenarios where, due to the dynamic assignment of HARQ process IDs, if a UE (i.e., UE-2) misses the PTM initial transmission which reuses the HARQ process ID of an earlier transmission (HARQ ID: 0001 as shown) because it, for example, failed to decode the group-common PDCCH scheduling this transmission, a NACK message could be transmitted for the PTM TB if semi-static type-1 codebook is used (i.e., there has been a unicast transmission to the UE). In these scenarios, if the gNB transmits a PTP retransmission of the PTM initial transmission, and if the UE did not receive the group-common PDCCH, and thus, is not aware there was the initial PTM transmission, the UE assumes that the network received a NACK instead of ACK causing the network to retransmit (i.e., the same HARQ ID and NDI is used). As a result, the UE would drop the PTP retransmission of the PTM initial transmission, resulting in the erroneous reception of the TB. Similarly, when UE-2 fails to receive the PTP transmission and sends a NACK, and the gNB either reaches the maximum number of retransmission for the TB or decodes the transmitted NACK as an ACK, the gNB may initiate the initial PTM transmission using the same HARQ ID. If UE-2 then misses the group-common PDCCH and sends NACK, the UE may attempt to soft-combine the received PTP retransmission of PTM traffic with the earlier received PTP traffic. This could cause the UE to send further NACKs to the gNB, all of which would end with failure to decode the TB. These scenarios may also occur if NACK-only feedback is configured (i.e., UE is configured to send HARQ NACK feedback in case of unsuccessful reception of a TB; however, the UE may not send feedback if the UE is able to decode the received TB (i.e., HARQ ACK feedback is not sent), and in case the UE misses the initial transmission and some other UE sends NACK feedback for which the gNB schedules a PTP retransmission.

Certain example embodiments described herein may have various benefits and/or advantages to overcome at least the disadvantages described above. For example, certain example embodiments may enhance the reliability of the multicast traffic reception as well as to improve the spectral efficiency of the network. Thus, certain example embodiments discussed below are directed to improvements in computer-related technology.

As discussed throughout herein, dummy or blank DCI may describe a DCI which, upon reception by a UE, is understood or inferred to be not mapped to any particular physical downlink shared channel and/or used to schedule any downlink data traffic.

FIG. 4 illustrates an example of a flow diagram of a method for sending a dummy or blank DCI to a UE in order to align the current value of the NDI field for the HPID intended to be used for the upcoming multicast transmission that may be performed by a NE, such as NE 1110 illustrated in FIG. 11, according to various example embodiments. This may occur in response to detecting a lack of NDI field alignment among UEs in a multicast group for the HPID intended to be used for multicast.

At 401, the method may include determining, by the NE, whether HPID is available for UEs in a multicast group with the same current NDI value. At 402, the method may further include, if the NE determines that there are no HPID available for UEs in a multicast group with the same current NDI value at 401, allocating, by the NE, HPID k with the least variation among the UEs in the multicast group for the current NDI value. At 403, the method may include selecting, by the NE, a smaller group of UEs with the same NDI value of group size k.

In some example embodiments, the UE may identify the dummy DCI based on the frequency domain resource allocation (FDRA) field, which could include multiple zeros for resource allocation (RA) type-0, or with the values of start PRB and length of PRBs=0 for RA type-1. RA type-0 may allocate the resources using a bitmap, with each bit representing one resource block group within the UE's bandwidth part—for unicast and common frequency resource for multicast. Similarly, RA type-1 may allocate the resources by providing the starting physical resource block (PRB), and a set of contiguous resource blocks subsequent to the starting PRB. In certain example embodiments, the NE may send a DCI with a random value within the FDRA field, where the DCI is configured to toggle the NDI field. Furthermore, other fields, such as time domain resource allocation (TDRA), may include all zeros within the DCI.

In certain example embodiments, the NE may determine the group of UEs to which the dummy DCI is sent based on the group size of UEs with different NDI values. The group of UEs will comprise any UE which current value of NDI is the same that the gNB is intending to use for the PTM transmission of new TB.

The method may further include, at 404, determining, by the NE, whether group size k is smaller than a configured threshold value. If group size k is smaller than a configured threshold value, then at 405, the method may include sending, by the NE, a dummy DCI to the group of UEs with CRC scrambled using C-RNTI, and the NDI value equal to that of the larger group.

However, if group size k is not smaller than the configured threshold value at 404, then at 406, the method may include determining, by the NE, a subgroup of UEs within the smaller group based upon channel conditions according to CSI feedback and/or OLLA, and at 407, sending a dummy DCI to the UEs with the worst channel conditions and/or highest probability of missing DCI reception. The CSI or other feedback information from the UE may indicate low values for reference signal received power (RSRP), reference signal received quality (RSRQ), prior or recent history of radio link failure reporting, etc. In addition, the CRC scrambled using C-RNTI and NDI value may be equal to that of the larger group.

In various example embodiments, the NE may determine the UEs to which the dummy DCI is sent based on the channel conditions of the UE. For example, the DCI may be sent to the UEs with the worst channel conditions or with a high probability of missing the PTM initial transmission DCI. Specifically, worst channel conditions may be determined based on the UE CSI feedback or based on open loop link adaptation techniques at the base station-based on the HARQ feedback.

Alternatively, at 408, if group size k is not smaller than the configured threshold value at 404, the method may include sending, by the NE, dummy DCI to the group of UEs with CRC scrambled using G-RNTI and an NDI value equal to that of the larger group.

In various example embodiments, the blank/dummy DCI transmitted at 405, 407, or 408 to the UEs may be configured to update the NDI field value of the latest transmission corresponding to the HPID and cause the UE to take no other action.

In various example embodiments, the NE may determine the RNTI value used for scrambling the DCI based on the group size of UEs with different NDI values.

At 409, the method may include sending, by the NE, initial PTM transmissions and/or subsequent PTM/PTM retransmissions with an NDI value toggled from the dummy DCI.

At 410, the method may further include configuring, by the NE, UEs that received dummy DCI to report and/or store indications of missed PTM initial transmissions if subsequent transmissions after the dummy DCI are not PTM.

In various example embodiments, the NE may configure the UEs to store or report instances where the UE does not receive a PTM initial transmission immediately subsequent to the reception of the dummy DCI. This report could be valuable to the NE, which would otherwise be unaware of missed initial PTM transmissions. Additionally or alternatively, the NE may configure the UE to store and report this information as part of minimization of drive test (MDT) feature.

FIG. 5 illustrates an example of a flow diagram of a method for receiving a dummy or blank DCI by a UE in order to align the current value of the NDI field for the HPID intended to be used for the upcoming multicast transmission that may be performed by a UE, such as UE 1110 illustrated in FIG. 11, according to various example embodiments.

At 501, the method may include receiving, by a user equipment, DCI from a network entity, such as NE 1120 illustrated in FIG. 11. In various example embodiments, the DCI may be free of grants for downlink data scheduling associated with the group of UE.

At 502, in response to receiving the DCI, the method may include updating, by the UE, a NDI field value of a latest transmission.

FIG. 6 illustrates an example of a signaling diagram for sending a dummy or blank DCI to a UE in order to align the current value of the NDI field for the HPID intended to be used for the upcoming multicast transmission. NE 610 and UE 620 may be similar to NE 1110 and UE 1120, as illustrated in FIG. 11, according to certain example embodiments.

At 601, NE 610 may determine whether HPID is available for UEs, including UE 620, in a multicast group with the same current NDI value. At 602, after determining that there are no HPID available for UEs in a multicast group with the same current NDI value at 601, NE 610 may allocate HPID k with the least variation among the UEs in the multicast group for the current NDI value. NE 610 may then select a smaller group of UEs with the same NDI value of group size k at 603.

In some example embodiments, the UE 620 may identify the dummy DCI based on the frequency domain resource allocation (FDRA) field, which could include multiple zeros for resource allocation (RA) type-0, or with the values of start PRB and length of PRBs=0 for RA type-1. In certain example embodiments, NE 610 may send a DCI with a random value within the FDRA field, where the intent of the DCI would be to toggle the NDI field. Furthermore, other fields, such as time domain resource allocation (TDRA), could include all zeros within the DCI.

In certain example embodiments, NE 610 may determine the group of UEs to which the dummy DCI is sent based on the group size of UEs with different NDI values. The group of UEs will comprise any UE which current value of NDI is the same that the gNB is intending to use for the PTM transmission of new TB.

At 604, NE 610 may determine whether group size k is smaller than a configured threshold value. If group size k is smaller than a configured threshold value, then at 605, NE 610 may send a dummy DCI to the group of UEs with CRC scrambled using C-RNTI, and the NDI value equal to that of the larger group.

However, if group size k is not smaller than the configured threshold value at 604, then at 606, NE 610 may determine a subgroup of UEs within the smaller group based upon channel conditions according to CSI feedback and/or OLLA, and at 607, send a dummy DCI to the UEs with the worst channel conditions and/or highest probability of missing DCI reception. The CSI or other feedback information from the UE may indicate low values for reference signal received power (RSRP), reference signal received quality (RSRQ), prior or recent history of radio link failure reporting, etc. In addition, the CRC scrambled using C-RNTI and NDI value may be equal to that of the larger group.

In various example embodiments, NE 610 may determine the UEs to which the dummy DCI is sent based on the channel conditions of the UE. For example, the DCI may be sent to the UEs with the worst channel conditions or with a high probability of missing the PTM initial transmission DCI. Specifically, worst channel conditions may be determined based on the UE CSI feedback or based on open loop link adaptation techniques at the base station—based on the HARQ feedback.

Alternatively, at 608, if group size k is not smaller than the configured threshold value at 604, NE 610 may transmit a dummy DCI to the group of UEs with CRC scrambled using G-RNTI and an NDI value equal to that of the larger group.

In various example embodiments, the blank/dummy DCI transmitted at 605, 607, or 608 to the UEs may be configured to update the NDI field value of the latest transmission corresponding to the HPID and cause UE 620 to take no other action.

In various example embodiments, the NE may determine the RNTI value used for scrambling the DCI based on the group size of UEs with different NDI values.

At 609, NE 610 may transmit initial PTM transmissions and/or subsequent PTM/PTM retransmissions with an NDI value toggled from the dummy DCI.

At 610, NE 610 may configure UEs that received dummy DCI to report and/or store indications of missed PTM initial transmissions if subsequent transmissions after the dummy DCI are not PTM.

In various example embodiments, NE 610 may configure the UEs to store or report instances where the UE does not receive a PTM initial transmission immediately subsequent to the reception of the dummy DCI. This report could be valuable to NE 610, which would otherwise be unaware of missed initial PTM transmissions. Additionally or alternatively, NE 610 may configure the UE to store and report this information as part of minimization of drive test (MDT) feature.

FIG. 7 illustrates some example embodiments of the dummy DCI transmission. In particular, the UE no longer has any issues with the PTP retransmission for the missed initial PTM transmission since the dummy DCI ensures that the current/latest NDI value for HPID ‘0001’ is toggled. Combined with the toggling of the PTM initial and PTP/PTM retransmissions, this ensures proper reception of the multicast traffic by the UE.

FIG. 8 illustrates some benefits of using the dummy DCI with predictable UE behavior based on legacy NDI field interpretation.

FIG. 9 depicts some possible DCI field values for the FDRA and TDRA field. Since the dummy DCI does not schedule any PDSCH resources, other DCI fields could be potentially set to a unique pattern as well indicating to the UE that the DCI is indeed a dummy DCI. Depending on the overall size and size of individual fields, the other characteristics of the DCI could follow related higher layer configurations.

FIGS. 10a-b illustrate possible user grouping based on current NDI value, where the UEs that are part of the smaller group are sent dummy DCIs. As a further optimization, the base station may send the dummy DCI to only a smaller group of UEs that have poor channel quality, determined based on channel state information/measurement reports. In this case, the UEs with the highest probability of missing the GC-PDCCH may be selected for transmitting the dummy DCI.

FIG. 11 illustrates an example of a system according to certain example embodiments. In one example embodiment, a system may include multiple devices, such as, for example, NE 1110 and/or UE 1120.

NE 1110 may be one or more of a base station, such as an eNB or gNB, a serving gateway, a server, and/or any other access node or combination thereof.

NE 1110 may further comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 1120 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 1110 and/or UE 1120 may be one or more of a citizens broadband radio service device (CBSD).

NE 1110 and/or UE 1120 may include at least one processor, respectively indicated as 1111 and 1121. Processors 1111 and 1121 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 1112 and 1122. The memory may be fixed or removable. The memory may include computer program instructions or computer code contained therein. Memories 1112 and 1122 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 1111 and 1121, memories 1112 and 1122, and any subset thereof, may be configured to provide means corresponding to the various blocks of FIGS. 4-6. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 11, transceivers 1113 and 1123 may be provided, and one or more devices may also include at least one antenna, respectively illustrated as 1114 and 1124. The device may have many antennas, such as an array of antennas configured for multiple input multiple output (MIMO) communications, or multiple antennas for multiple RATs. Other configurations of these devices, for example, may be provided. Transceivers 1113 and 1123 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 4-6). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 4-6. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

FIG. 12 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 12 may be similar to NE 1110 and UE 1120, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 1111 and 1121, and memories 1112 and 1122, may be included in or may form a part of processing circuitry or control circuitry. In addition, in some example embodiments, transceivers 1113 and 1123 may be included in or may form a part of transceiving circuitry.

In some example embodiments, an apparatus (e.g., NE 1110 and/or UE 1120) may include means for performing a method, a process, or any of the variants discussed herein. Examples of the means may include one or more processors, memory, controllers, transmitters, receivers, and/or computer program code for causing the performance of the operations.

In various example embodiments, apparatus 1110 may be controlled by memory 1112 and processor 1111 to select a smaller group of user equipment with the same new data indicator value from among two groups of user equipment of a group size smaller than a configured threshold value; transmit downlink control information to the group of user equipment; and transmit at least one of initial point-to-point transmissions and subsequent point-to-point or point-to-multipoint retransmissions with the new data indicator value toggled from the downlink control information. The downlink control information may be free of grants for downlink data scheduling associated with the group of user equipment.

In various example embodiments, apparatus 1110 may be controlled by memory 1112 and processor 1111 to receive downlink control information from a network entity; and, in response to receiving the downlink control information, update a new data indicator field value of latest transmission. The downlink control information may be free of grants for downlink data scheduling associated with the group of user equipment.

Certain example embodiments may be directed to an apparatus that includes means for performing any of the methods described herein including, for example, means for selecting a smaller group of user equipment with the same new data indicator value from among two groups of user equipment of a group size smaller than a configured threshold value; means for transmitting downlink control information to the group of user equipment; and means for transmitting at least one of initial point-to-point transmissions and subsequent point-to-point or point-to-multipoint retransmissions with the new data indicator value toggled from the downlink control information. The downlink control information may be free of grants for downlink data scheduling associated with the group of user equipment.

Certain example embodiments may be directed to an apparatus that includes means for performing any of the methods described herein including, for example, means for receiving downlink control information from a network entity; and means for, in response to receiving the downlink control information, updating a new data indicator field value of latest transmission. The downlink control information may be free of grants for downlink data scheduling associated with the group of user equipment.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP Third Generation Partnership Project
5G Fifth Generation
5GC Fifth Generation Core
5GS Fifth Generation System
5QI Fifth Generation Quality of Service Indicator
ACK Acknowledgement
AMF Access and Mobility Management Function
ARQ Automatic Repeat Request
ASIC Application Specific Integrated Circuit
BS Base Station
BSR Buffer Status Report
CAPC Channel Access Priority Class
CBSD Citizens Broadband Radio Service Device
CCCH Common Control Channel
CCE Control Channel Element
CE Control Elements
CN Core Network
CORESET Control Resource Set
CPU Central Processing Unit
CRC Cyclic Redundancy Check
C-RNTI Cell-Radio Network Temporary Identity
CSI Channel State Information
CU Centralized Unit
DCCH Dedicated Control Channel
DCI Downlink Control Information
DL Downlink
DU Distributed Unit
eMBB Enhanced Mobile Broadband
eMTC Enhanced Machine Type Communication
eNB Evolved Node B
eOLLA Enhanced Outer Loop Link Adaptation
EPS Evolved Packet System
FDRA Frequency Domain Resource Allocation
GC-PDCCH Group Common Physical Downlink Control Channel
GC-PDSCH Group Common Physical Downlink Shared Channel
GCS-RNTI Group-Common Configured Scheduling Radio Network Temporary Identifier
gNB Next Generation Node B
G-RNTI Group Radio Network Temporary Identifier
GPS Global Positioning System
HARQ Hybrid Automatic Repeat Request
HDD Hard Disk Drive
HPID Hybrid Automatic Repeat Request Process Identifier
IoT Internet of Things
L1 Layer 1
L2 Layer 2
LCH Logical Channel
LTE Long-Term Evolution
LTE-A Long-Term Evolution Advanced
MAC Medium Access Control
MBS Multicast and Broadcast Systems
MC Multicast
MEMS Micro Electrical Mechanical System
MIB Master Information Block
MIMO Multiple Input Multiple Output
mMTC Massive Machine Type Communication
MPDCCH Machine Type Communication Physical Downlink Control Channel
MTC Machine Type Communication
NACK Negative Acknowledgement
NAS Non-Access Stratum
NB-IoT Narrowband Internet of Things
NDI New Data Indicator
NE Network Entity
NG Next Generation
NG-eNB Next Generation Evolved Node B
NG-RAN Next Generation Radio Access Network
NR New Radio
NR-U New Radio Unlicensed
OLLA Outer Loop Link Adaptation
OTA Over-the-air
PBR Prioritized Bit Rate
PDA Personal Digital Assistance
PDCCH Physical Downlink Control Channel
PDSCH Physical Downlink Shared Channel
PDU Protocol Data Unit
PRACH Physical Random Access Channel
PRB Physical Resource Block
P-RNTI Paging Radio Network Temporary Identifier
PTM Point-to-Multipoint
PTP Point-to-Point
PUCCH Physical Uplink Control Channel
PUSCH Physical Uplink Shared Channel
QoS Quality of Service
RAM Random Access Memory
RAN Radio Access Network
RAT Radio Access Technology
RE Resource Element
RLC Radio Link Control
RNTI Radio Network Temporary Identifier
RRC Radio Resource Control
RS Reference Signal
RSRP Reference Signal Received Power
RSRQ Reference Signal Received Quality
SC-PTM Single Cell-Point-to-Multipoint
SC-RNTI Single-Cell Radio Network Temporary Identifier
SMF Session Management Function
TDRA Time Domain Resource Allocation
TR Technical Report
TS Technical Specification
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio Access Network
WLAN Wireless Local Area Network

1-30. (canceled)

31. An apparatus, comprising:
at least one processor; and
at least one memory including computer program code;
the at least one memory and the computer program code configured to, with the at least one processor, cause the apparatus at least to:
select a smaller group of user equipment with same new data indicator value from among two groups of user equipment;
transmit downlink control information to the smaller group of user equipment, wherein the downlink control information is free of grants for downlink data scheduling associated with the smaller group of user equipment, and wherein the downlink control information comprises a second new data indicator value toggled from the new data indicator value of the smaller group of user equipment; and
transmit at least one of initial point-to-multipoint transmission and subsequent point-to-point or point-to-multipoint retransmissions with new data indicator value toggled from the downlink control information.

32. The apparatus of claim 31, wherein the apparatus is further caused to:
determine whether a group size of the smaller group of user equipment is smaller than a configured threshold value

33. The apparatus of claim 32, wherein the transmitting downlink control information comprises:
in response to determination that the group size of the smaller group of user equipment is smaller than the configured threshold value, transmitting the downlink control information to the smaller group of user equipment with cyclic redundancy check scrambled using cell radio network temporary identity, and the second new data indicator value equals to new data indicator value of the larger group.

34. The apparatus of claim 32, wherein the transmitting downlink control information comprises:
in response to determination that the group size of the smaller group of user equipment is not smaller than the configured threshold value, transmitting the downlink control information to the group of user equipment with cyclic redundancy check scrambled using group radio network temporary identifier, and the second new data indicator value equals to new data indicator value of the larger group.

35. The apparatus of claim 31, wherein the apparatus is further caused to:
determine a subgroup of user equipment within the smaller group based upon channel conditions according to channel state information feedback and/or outer loop link adaptation.

36. The apparatus of claim 31, wherein the apparatus is further caused to:
determine whether hybrid automatic repeat request process identifier is available for user equipment in a multicast group with the same current new data indicator value.

37. The apparatus of claim 36, wherein the apparatus is further caused to:
allocate hybrid automatic repeat request process identifiers with the least variation among the user equipment in the multicast group for the current new data indicator value if the network entity determines that there are no hybrid automatic repeat request process identifiers available for user equipment in the multicast group with the same current new data indicator value.

38. The apparatus of claim 31, wherein the apparatus is further caused to:
detect, prior to the selecting the smaller group of user equipment, a lack of alignment of new data indicator field associated with a hybrid automatic repeat request process identifier, HPID, among user equipment in a multicast group in a point-to-point or point-to-multipoint transmission.

39. An apparatus, comprising:
at least one processor; and
at least one memory including computer program code;
the at least one memory and the computer program code configured to, with the at least one processor, cause the apparatus at least to:
receive downlink control information from a network entity, wherein the downlink control information is free of grants for downlink data scheduling of the apparatus; and
update, in response to receiving the downlink control information, a new data indicator field value of latest transmission.

40. The apparatus of claim 39, wherein the apparatus is in a smaller group of user equipment with same new data indicator value among two groups of user equipment, and wherein the downlink control information comprises a second new data indicator value toggled from the new data indicator value of the smaller group of user equipment.

41. The apparatus of claim 40, wherein updating the new data indicator field value comprises updating the new data indicator field value based on the second new data indicator value of the downlink control information.

42. The apparatus of claim 39, wherein the downlink control information comprises a hybrid automatic repeat request process identifier, HPID, and updating the new data indicator field value of latest transmission comprises updating the new data indicator field value of latest transmission associated with the HPID.

43. The apparatus of claim 39, wherein the apparatus is further caused to:
determine the downlink control information is free of grants based on a frequency domain resource allocation (FDRA) field or a time domain resource allocation (TDRA) field with a preconfigured value.

44. The apparatus of claim 39, wherein the apparatus is further caused to:
receive a configuration to store and/or report instances not receiving a point-to-multipoint initial transmission subsequent to the reception of the downlink control information.

45. A method, comprising:
receiving, by a user equipment, downlink control information from a network entity, wherein the downlink control information is free of grants for downlink data scheduling of the user equipment; and
in response to receiving the downlink control information, updating, by the user equipment, a new data indicator field value of latest transmission.

46. The method of claim 45, wherein the user equipment is in a smaller group of user equipment with same new data indicator value among two groups of user equipment, and wherein the downlink control information comprises a second new data indicator value toggled from the new data indicator value of the smaller group of user equipment.

47. The method of claim 46, wherein updating the new data indicator field value comprises updating the new data indicator field value based on the second new data indicator value of the downlink control information.

48. The method of claim 45, wherein the downlink control information comprises a hybrid automatic repeat request process identifier, HPID, and updating the new data indicator field value of latest transmission comprises updating the new data indicator field value of latest transmission associated with the HPID.

49. The method of claim 45, further comprising:
determining the downlink control information is free of grants based on a frequency domain resource allocation (FDRA) field or a time domain resource allocation (TDRA) field with a preconfigured value.

50. The method of claim 45, further comprising:
receiving a configuration to store and/or report instances not receiving a point-to-multipoint initial transmission subsequent to the reception of the downlink control information.
